(19) United States
(12) Patent Application Publication
(10) Pub. No.: US 2025/0050247 A1
(43) Pub. Date: Feb. 13, 2025

(54) FILTER FOR A BASKET, BASIN, OR SINK

(71) Applicant: BEARD BIN, LLC, Dania Beach, FL (US)

(72) Inventors: Antranik Krikor KALAYDJIAN, Dania Beach, FL (US); John Richard VOLPE, Los Angeles, CA (US); Arjun Gladville DAVID, Southbank (AU)

(73) Assignee: BEARD BIN, LLC, DANIA BEACH, FL (US)

(21) Appl. No.: 18/366,651

(22) Filed: Aug. 7, 2023

(51) Int. Cl. B01D 29/01; B01D 35/02

(52) U.S. Cl. CPC B01D 29/016; B01D 29/012; B01D 35/02; E03C 2201/40

(57) ABSTRACT

Improvements to a liquid permeable barrier or filter for a basket, basin, or sink. An expandable filter for a basket, basin, or sink, the filter including a filter material shaped and formed to having a peripheral region, a plurality of panels, and a central collection region, the peripheral region having an upper surface and a lower surface, and the plurality of panels extending from the central collection region towards the peripheral region; and one or more folds in the filter, each of the one or more folds permitting each of the plurality of panels to overlap an adjacent portion of the filter, wherein the filter can be unfolded from a folded orientation to a partially unfolded orientation.

### FIELD OF DISCLOSURE

The present disclosure relates to basket, basin, and sink liners, and more particularly, to improvements to a liquid permeable barrier or filter for a basket, basin, or sink.

### BACKGROUND

There are very few types of known sink liners. One known sink liner can be a filter for a sink including a substantially inverted disposed conical filter having a rounded conical apex and a continuous horizontally disposed circular bottom rim. The known filter also includes a circular top rim continuously disposed on a top surface of the bottom rim of the filter and a concave-shaped indentation continuously disposed through each of an exterior edge of the bottom rim and an outer surface of the top rim. The known filter also includes a plurality of tabs attached to the outer surface of the top rim and an adhesive layer disposed on a bottom surface of the bottom rim of the filter. The known filter can be removably disposed atop an exterior surface of a sink, with an exterior edge of the indentation disposed around an exterior surface of a base of a faucet. The known filter for a sink can be structured to be removably disposed atop a sink in order to catch debris, including toenail and fingernail clippings, beard trimmings, and hair, that would ordinarily flow into a sink drain and potentially clog a sink pipe. The adhesive layer disposed on the bottom rim of the conventional filter maintains the position of the filter within the sink while in use.

Certain conventional basket tilters used for automatic drip coffee makers can utilize a series of ruffled edges, to fit a specific basket-like shape that a filter housing for a particular coffee maker may have. For example, one filter housing for an automatic drip coffee maker has an angle of about 60 degrees. A conventional basket filter made for this particular filter housing utilizes a series of ruffled edges along the sides of the filter to evenly and quickly spread the water throughout the ground coffee when both are placed in the filter to facilitate the filtration of the mixture of water and coffee grounds through the conventional basket filter. Other conventional filters used for automatic drip coffee makers can utilize a folded and crimped design, to better accommodate relatively smaller packaging to minimize shipping cost. In certain instances, a folded conventional filter may provide a relatively limited surface area for filtering.

### BRIEF SUMMARY OF THE DISCLOSURE

Embodiments of the disclosure can include improvements to a filter for a basket, basin, or sink. Certain embodiments of the disclosure can alleviate the need for an adhesive layer on the bottom rim of the conventional filter to maintain the position of the filter within the basket, basin, or sink while in use. Further, certain embodiments of the disclosure can alleviate the need to avoid damaging the conventional filter during storage and prior to use of the filter in a basket, basin, or sink. In addition, certain embodiments of the disclosure can alleviate the need to avoid leaving an adhesive residue on an upper surface of a basket, basin, or sink. Moreover, certain embodiments of the disclosure can reduce environmental waste as well as reduce production costs over conventional filters for a basket, basin, or sink. One will recognize that various embodiments of the disclosure can be utilized as a particle collection barrier or filter for a basin, sink, or basket.

In one embodiment, an improved filter for a basket, basin, or sink can be provided. The filter can include a filter having a peripheral region, a plurality of panels, and a central collection region, the peripheral region having an upper surface and a lower surface, and the plurality of panels extending from the central collection region towards the peripheral region; and one or more folds in the filter, each of the one or more folds permitting each of the plurality of panels to overlap an adjacent portion of the filter, wherein the filter can be unfolded from a folded orientation to a partially unfolded orientation.

In one aspect of the embodiment, the filter can include at least one tab along the exterior edge of the peripheral region.

In one aspect of the embodiment, the filter can include an indentation in an exterior edge of the peripheral region, wherein the indentation is disposed around an external surface of a base of a faucet when the filter is disposed atop the exterior surface of the basket, basin, or sink.

In one aspect of the embodiment, the filter can include at least one of the following: bleached or unbleached liquid permeable filter paper, liquid permeable filter paper, metal mesh material, plastic mesh material, natural fiber material, and synthetic fabric.

In one aspect of the embodiment, the central collection region can be polygon-shaped, and the plurality of panels can be polygon-shaped.

In one aspect of the embodiment, the plurality of panels can be four.

In one aspect of the embodiment, the one or more folds can include a set of origami-type folds that permits twisting of the filter around a central axis when unfolding the filter from the folded orientation to the partially unfolded orientation.

In one aspect of the embodiment, the one or more folds can include at least one of the following: a square twist, and a tessellation fold.

In another embodiment, a method for installing an improved filter for a basket, basin, or sink can be provided. The method can include providing a filter having a peripheral region, a plurality of panels, a central collection region, the peripheral region having an upper surface and a lower surface, and the plurality of panels extending from the central collection region towards the peripheral region. The method can further include unfolding the filter along one or more folds in the filter, each of the one or more folds permitting each of the plurality of panels to overlap an adjacent portion of the filter, wherein the filter can be unfolded from a folded orientation to a partially unfolded orientation. The method can also include disposing the filter atop an exterior surface of a basket, basin, or sink, wherein the lower surface of the rim is disposed around an external surface of a base of a faucet when the filter is disposed atop the exterior surface of the basket, basin or sink.

In one aspect of the embodiment, the filter can include at least one tab along the exterior edge of the peripheral region.

In one aspect of the embodiment, the filter can include at least one of the following: bleached or unbleached liquid permeable filter paper, metal mesh material, plastic mesh material, natural fiber material, and synthetic fabric.

In one aspect of the embodiment, the central collection region can be square-shaped, and the plurality of panels can be polygon-shaped.

In one aspect of the embodiment, the plurality of panels can be four.

In one aspect of the embodiment, the one or more folds can include a set of origami-type folds that permits twisting of the filter around a central axis when unfolding the filter from the folded orientation to the partially unfolded orientation.

In one aspect of the embodiment, the one or more folds can include at least one of the following: a square twist, and a tessellation fold.

In yet another embodiment, a manufacturing process for an improved filter for a basket, basin, or sink can be provided. The process can include providing a filter material, and providing a die to mold the filter material. The process can further include molding the filter material to manufacture a filter for a basket, basin, or sink, the filter including a peripheral region; a plurality of panels; a central collection region, the peripheral region having an upper surface and a lower surface, and the plurality of panels extending from the central collection region towards the peripheral region; each of the one or more folds permitting each of the plurality of panels to overlap an adjacent portion of the filter, wherein the filter can be unfolded from a folded orientation to a partially unfolded orientation.

In one aspect of the embodiment, the molding the filter can include molding the filter to make the central collection region square-shaped, and the plurality of panels rectangular-shaped.

In one aspect of the embodiment, the molding the filter can include molding the filter to make the one or more folds comprising a set of origami-type folds that permits twisting of the filter around a central axis when unfolding the filter from the folded orientation to the partially unfolded orientation.

In one aspect of the embodiment, the molding the filter can include molding the filter to make the one or more folds comprising at least one of the following: a square twist, and a tessellation fold.

In one aspect of the embodiment, the filter can include a concave-shaped indentation in an exterior edge of the peripheral region; and a plurality of tabs along the exterior edge of the rim, wherein one of the plurality of tabs is disposed adjacent the concave-shaped indentation.

### BRIEF DESCRIPTION OF THE DRAWINGS

The detailed description is set forth with reference to the accompanying drawings. The drawings are provided for purposes of illustration only and merely depict exemplary embodiments of the disclosure. The drawings are provided to facilitate understanding of the disclosure and shall not be deemed to limit the breadth, scope, or applicability of the disclosure. In the drawings, the left-most digit(s) of a reference numeral may identify the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 is a top plan view of an example filter in a folded orientation, according to at least one embodiment of the disclosure.

FIG. 2 is a top plan view of an example filter in a partially unfolded orientation, according to at least one embodiment of the disclosure.

FIG. 3 is a perspective view of an example filter in a folded orientation, according to at least one embodiment of the disclosure.

FIG. 4 is a top view of an example filter in a partially unfolded orientation, according to at least one embodiment of the disclosure.

FIG. 5 is a top view of an example filter in a folded orientation, according to at least one embodiment of the disclosure.

FIG. 6 is a bottom view of an example filter in a partially unfolded orientation, according to at least one embodiment of the disclosure.

FIG. 7 is a bottom view of an example filter in a folded orientation, according to at least one embodiment of the disclosure.

FIG. 8 is a front view of an example filter in a folded orientation, according to at least one embodiment of the disclosure.

FIG. 9 is a front view of an example filter in a partially unfolded orientation, according to at least one embodiment of the disclosure.

FIG. 10 is a back view of an example filter in a folded orientation, according to at least one embodiment of the disclosure.

FIG. 11 is a left side view of an example filter in a folded orientation, according to at least one embodiment of the disclosure.

FIG. 12 is a right side view of an example filter in a folded orientation, according to at least one embodiment of the disclosure.

FIGS. 13A-13C is a series of views illustrating an example filter being deployed from a folded orientation to a partially unfolded orientation adjacent to an exterior surface of a basket, basin, or sink, according to at least one embodiment of the disclosure.

FIG. 14 is a top view of another example rectangular-shaped filter in an unfolded orientation, according to at least one embodiment of the disclosure.

FIG. 15 is a top view of an example rectangular-shaped filter in a folded orientation, according to at least one embodiment of the disclosure.

### DETAILED DESCRIPTION

### Overview

This disclosure relates to, among other things, improvements to a disposable filter for a basket, basin, or sink. In one or more embodiments, the improvements to a filter for a basket, basin, or sink described herein may improve upon conventional filters for a basket, basin, or sink by using an innovative and unique overall shape and expandable configuration for a disposable filter for a basket, basin, or sink. The disclosure addresses certain needs by providing various technical solutions such as avoiding the use of a layer of adhesive on a bottom surface of a conventional filter to maintain the position of the filter within the basket, basin, or sink while in use, avoiding leaving an adhesive residue on an upper surface of a basket, basin, or sink, and avoiding damaging a conventional filter during storage and prior to use of the filter in a basket, basin, or sink.

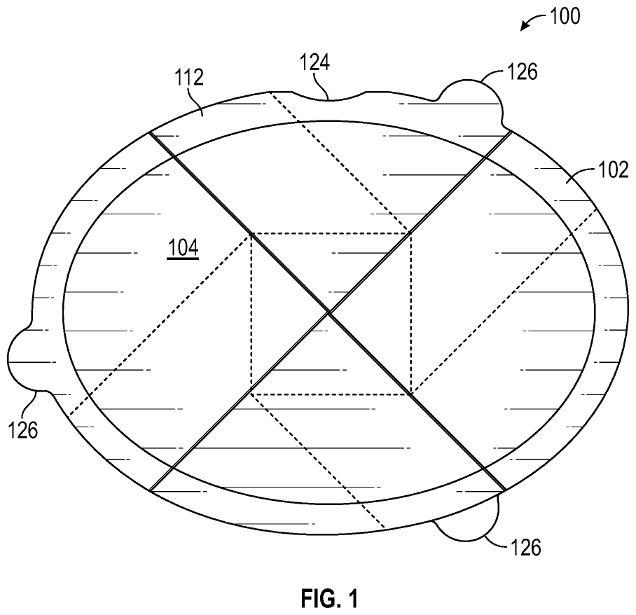

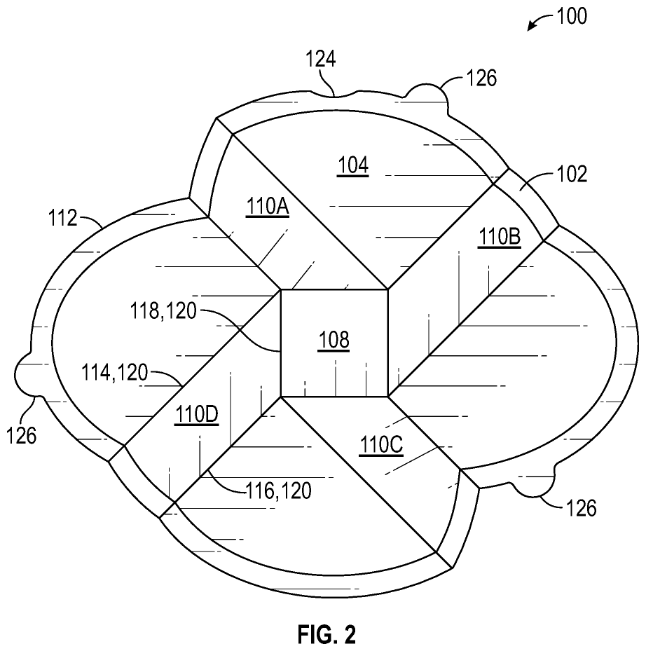

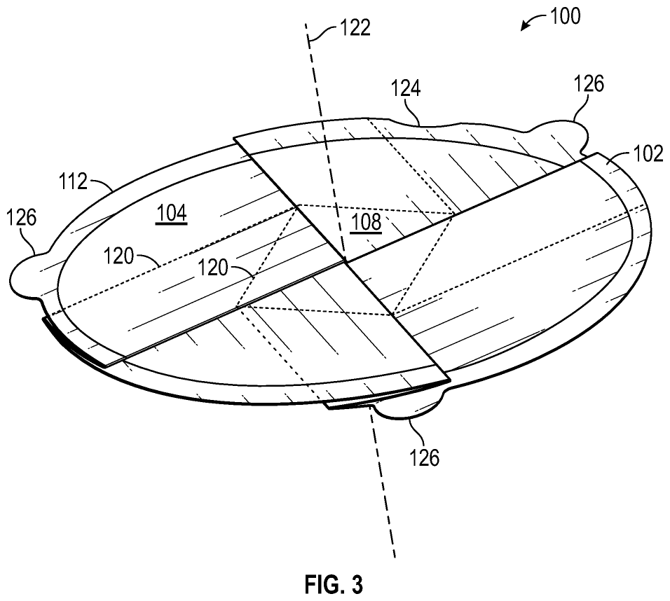

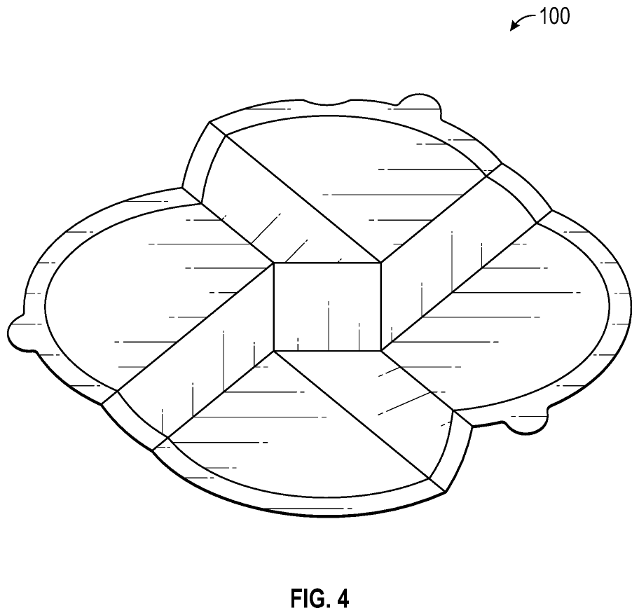

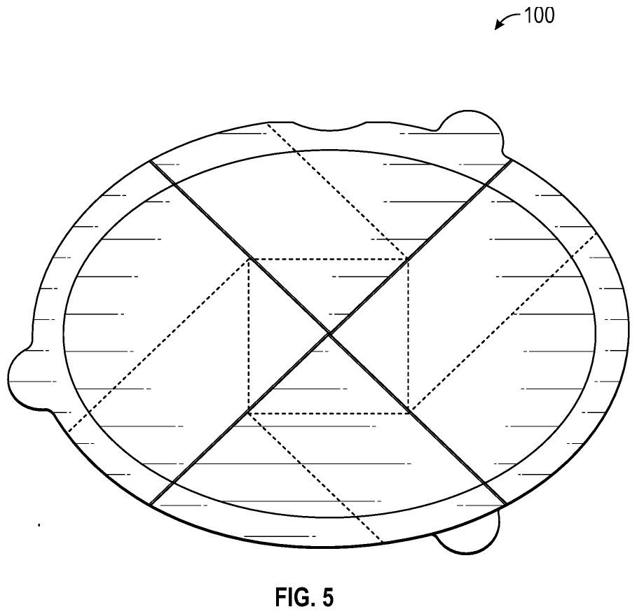

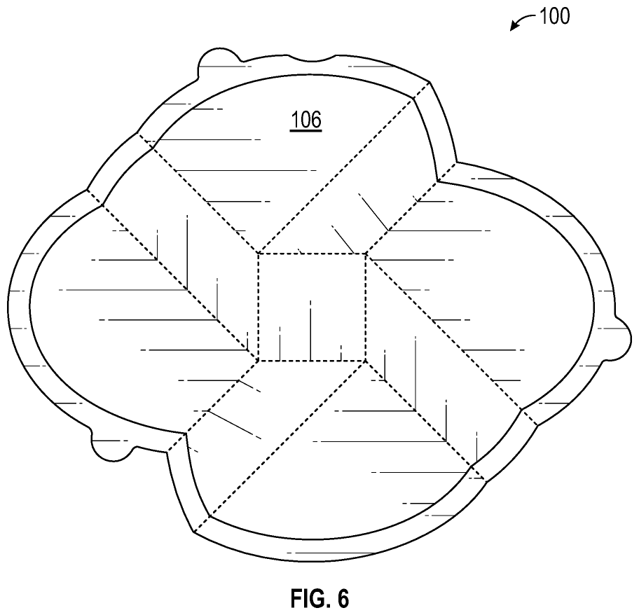

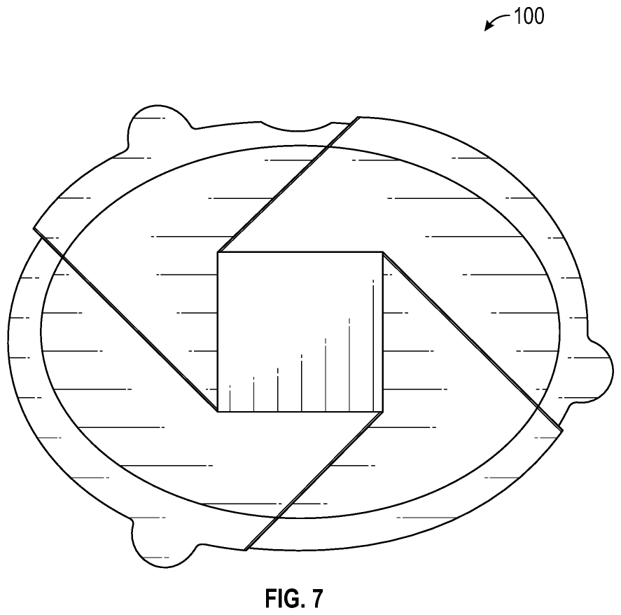

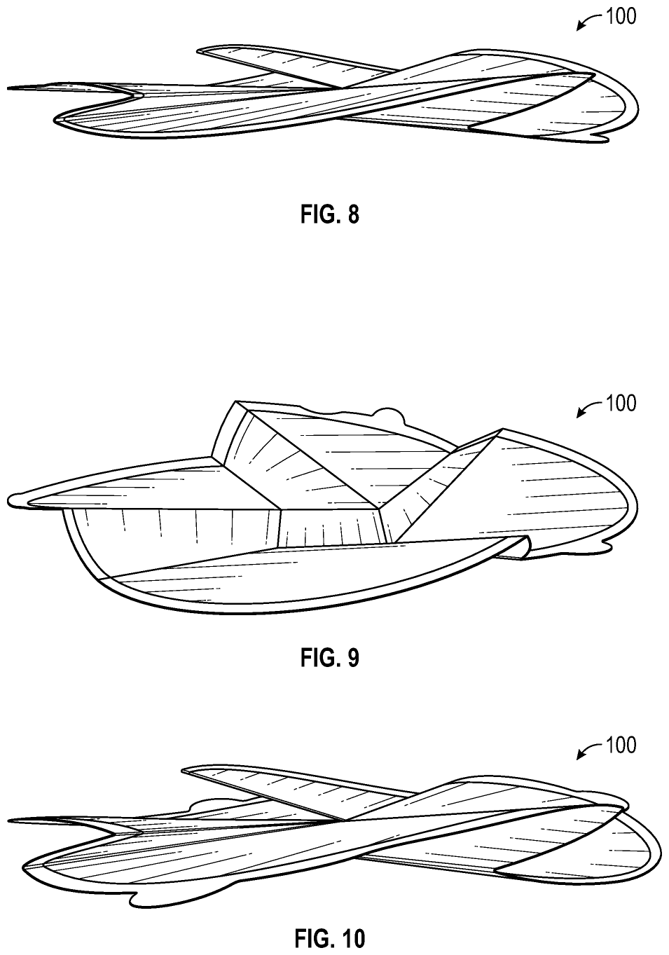

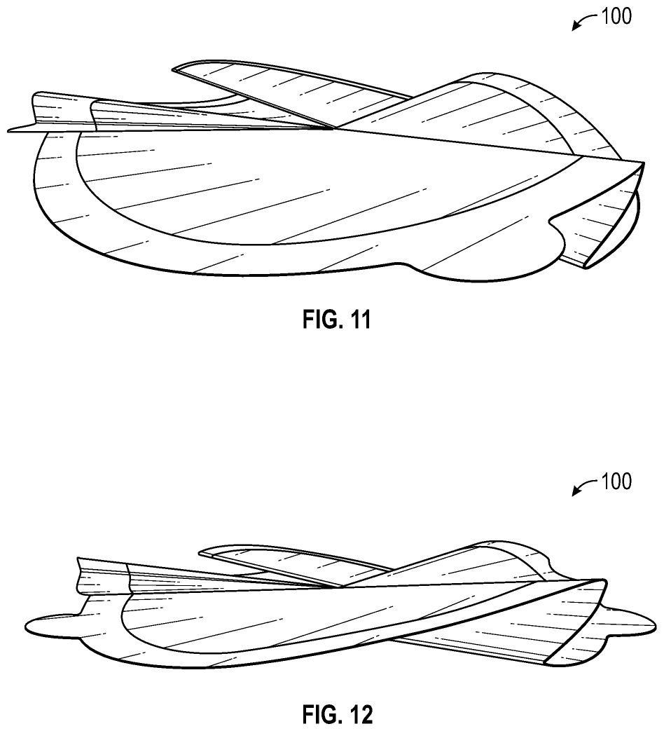

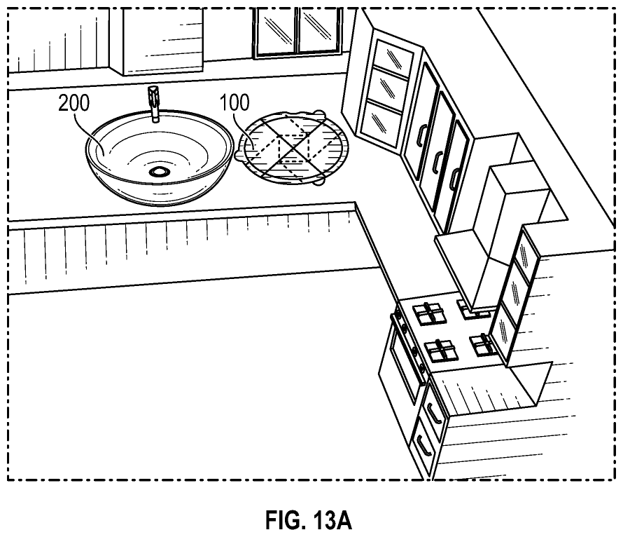

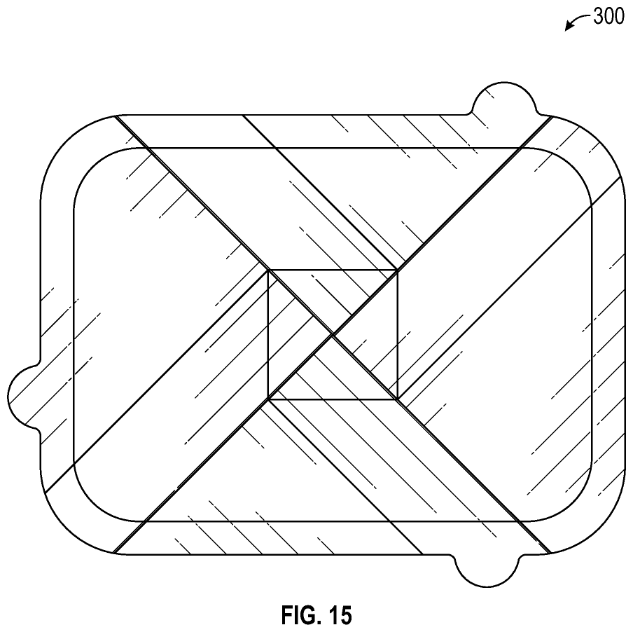

With reference now to the drawings, and in particular FIGS. 1 through 13A-13C, an example embodiment of a filter for a basket, basin, or sink employing certain innovative and unique principles and concepts will be described. One will recognize that the embodiment described below is one example of a filter for a basket, basin, or sink, and that the scope of the disclosure can include other examples and embodiments employing similar innovative and unique principles and concepts described below. Further. FIGS. 14 and 15 illustrate a rectangular-shaped filter for a basket, basin, or sink, and one will recognize the applicability of the principles and concepts described herein to this and other embodiments.

In FIGS. 1 to 12, an example filter 100 for a basket, basin, or sink is illustrated, according to at least one embodiment of the disclosure. The filter 100 for a basket, basin, or sink can include a peripheral region 102 having an upper surface 104 and a lower surface 106, a central collection region 108, and a plurality of panels 110 extending from the central collection region 108 towards the peripheral region 102.

The filter 100 shown in FIGS. 1 to 12 is irregular oval-shaped, and the overall shape of the filter 100 can be altered between irregular oval-shaped and oval-shaped by manipulating or otherwise folding the filter 100 initially from the partially unfolded orientation to the folded orientation, and subsequently from the folded orientation to the partially unfolded orientation. In some instances, a filter can be circular, square, rectangular, polygonal, or any other geometric-shape if being sized for a particular shape of basket, basin, or sink. For example, an embodiment of a rectangular-shaped filter 300 is shown in FIGS. 14 and 15. Example dimensions for the filter 100 shown in FIGS. 1 to 12 in a fully unfolded orientation can be approximately 33 inches (83.8 cm) by 27 3/16 inches (68.1 cm) by 1/64 inches (0.04 cm) for a basin or sink manufactured by Kohler Company of Kohler, Wisconsin. In a folded orientation, example dimensions for the filter 100 can be approximately 21¾ inches (51.4 cm) by 16 3/16 inches (40.6 cm) by 1/16 inches (0.16 cm). When in a folded orientation, the filter 100 can be oval-shaped. Example dimensions for the filter 300 shown in FIGS. 14 and 15 in a fully unfolded orientation can be approximately 30 9/32 inches (75.5 cm) by 25⅜ inches (62.5 cm) by 1/64 inches (0.04 cm). In a folded orientation, example dimensions for the filter 300 can be approximately 21⅜ inches (52.4 cm) by 17½ inches (41.9 cm) by 1/16 inches (0.16 cm). The filter 100 shown in FIGS. 1 to 12, and the filter 300 in FIGS. 14 and 15, can be made from approximately 50 gsm (grams per square meter) unbleached or bleached liquid permeable filter paper metal mesh material, plastic mesh material, natural fiber material, or synthetic fabric, but may be, in some instances, made from any suitable filtration material at a variety of thickness grades, that can filter water and can be sized to fit within a basket, basin, or sink. One will recognize the filters 100, 300, in a partially unfolded orientation, can be a variety of shapes, including circular, oval, square, rectangular, polygonal, or geometrical, depending on the design of a particular basket, basin, or sink the respective filters 100, 300 are to be used with, and further depending on the desired storage configuration for the filters 100, 300 in the folded orientation. Further, one will recognize the filters 100, 300 can be made from any variety of suitable filtration materials.

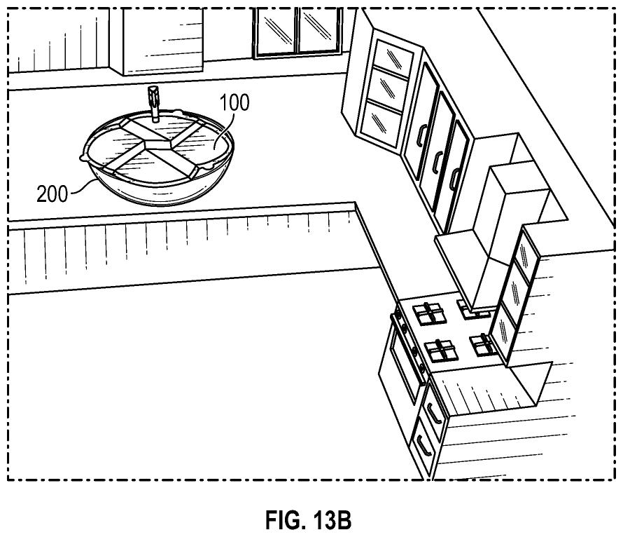

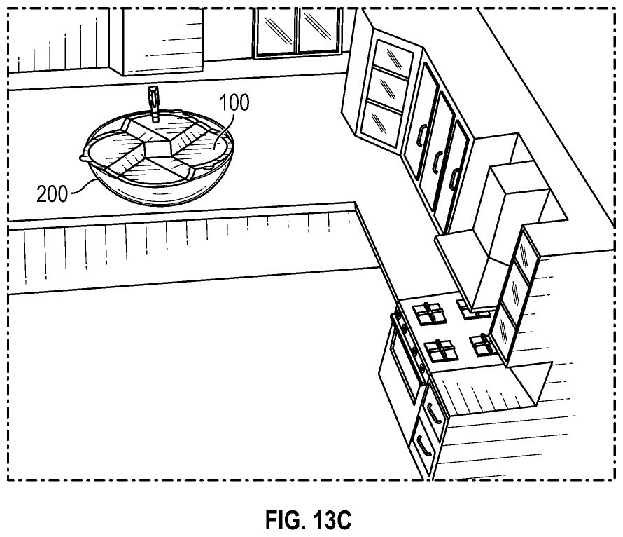

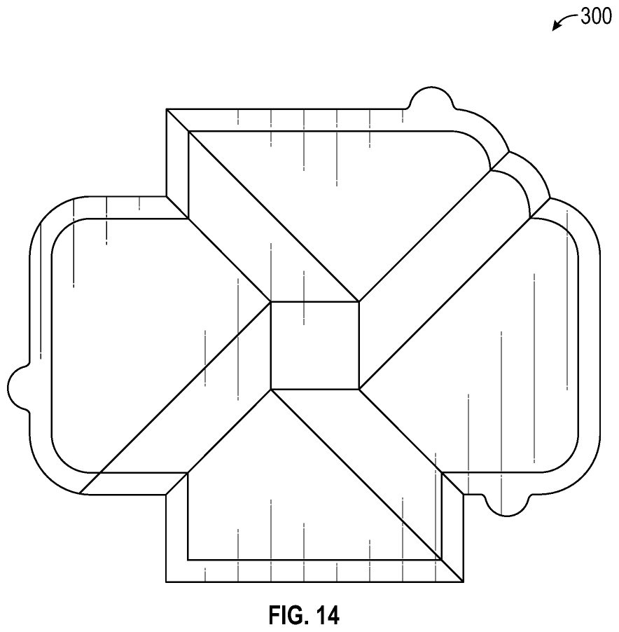

The upper surface 104 and lower surface 106 of the peripheral region 102 shown in FIGS. 1 to 12 can intersect at an exterior edge 112 of the peripheral region 102, thus the peripheral region 102 runs circumferentially along the outer edge of the filter 100. The thickness of the peripheral region 102 can, in some instances, be relatively thicker than the other portions of the disposable filter 100. In the example shown, the relative thickness of the peripheral region 102 is substantially the same thickness of the other portions of the disposable filter 100. In any instance, the disposable filter 100 can be removably disposed atop an exterior surface of a basket, basin, or sink, shown as 200 and 202 in FIGS. 13A-13C, with the lower surface 106 of some or all of the peripheral region 102 in substantial contact with the basket, basin, or sink 200.

The central collection region 108 shown in FIGS. 1 to 12 can be square-shaped. The central collection region 108 can generally be centrally located on the filter 100, and is configured to be a portion of the filter 100 that is positioned adjacent to the lowest part of the exterior surface 202 of a basket, basin, or sink 200, when the filter 100 is disposed atop the exterior surface 202 of the basket, basin, or sink 200. One will recognize the central collection region 108 can be a variety of shapes, including circular, oval, rectangular, or polygonal, depending on the design of a particular basket, basin, or sink the filter 100 is to be used with. Further, one will recognize the central collection region 108 can be located in other positions relative to the shape of the filter 100 and depending on the configuration of the design of a particular basket, basin, or sink the filter 100 is to be used with and the lowest part of an exterior surface of the basket, basin, or sink.

The plurality of panels 110, shown in FIGS. 1 to 12, extending from the central collection region 108 towards the peripheral region 102 can be polygon-shaped. In this example embodiment, there are four panels 110A-110D, with each of the panels 110A-110D being respectively adjacent to at least one side of the central collection region 108, and each of the panels 110A-110D extending to the peripheral region 102. One will recognize the applicability of the principles and concepts described herein to this and other embodiments, such as embodiments with three or five panels extending to the peripheral region 102.

Each of the panels 110A-110D has a pair of spaced apart lateral sides 114, 116, that extend from the central collection region 108 towards the peripheral region 102. Further, each of the panels 110A-110D has an internal side 118 adjacent to the central collection region 108. Each of the lateral sides 114, 116 and the internal side 118 of the panels 110A-110D can be included in a series of folds 120 in the material of the filter 100, wherein the collective series of folds from all of the lateral sides 114, 116 and internal side 118 of the panels 110A-110D permits the each of the panels 110A-110D to overlap an adjacent portion of the filter 100, wherein the filter 100 can initially be folded from a partially unfolded orientation to a folded orientation, and subsequently, from the folded orientation to the partially unfolded orientation to use or deploy the filter 100 with a basket, basin, or sink 200.

In the example embodiment shown in FIGS. 1 to 12, the series of folds 120 can include a set of origami-type folds that permit twisting of the filter 100 around a central axis 122 when initially folding the filter 100 from a partially unfolded orientation to a folded orientation, and subsequently, from the folded orientation to the partially unfolded orientation to use or deploy the filter 100. The series of folds 120 can include one or more folds to create a square twist or a tessellation-type fold in the filter 100. In the embodiment shown in FIGS. 1 to 12, the central axis 122 can be an imaginary line that runs perpendicular through the central collection region 108 when the filter 100 is in a partially unfolded orientation.

As described above, the example dimensions for the filter 100 shown in FIGS. 1 to 12 in a fully unfolded orientation can be approximately 33 inches (83.8 cm) by 27 3/16 inches (68.1 cm) by 1/64 inches (0.04 cm), whereas in a folded orientation, example dimensions for the filter 100 can be approximately 21¾ inches (51.4 cm) by 16 3/16 inches (40.6 cm) by 1/16 inches (0.16 cm). The ability of the filter 100 to be folded into a relatively compact size creates a significant savings in storage space for the filter 100 since the folded width and height am significantly smaller than the partially unfolded width and height.

The filter 100 shown in FIGS. 1 to 12 can also include a concave-shaped indentation 124 that is molded, formed, or otherwise cut into the exterior edge 112 of the peripheral region 102 of the filter 100. Further, the filter 100 shown in FIGS. 1 to 12 can include a plurality of tabs 126 that may be molded, formed, or otherwise attached to either or both of the upper surface 104 and lower surface 106 of the peripheral region 102. In the example embodiment shown, at least one of the plurality of tabs 126, such as 126A, can be disposed proximal to the concave-shaped indentation 124. Each of the plurality of tabs 126 can be optionally substantially semi-circular, and the plurality of tabs 126 can optionally be three total. One will recognize that the shape, number, and positions of the indentation and tabs can be changed in other embodiments of the disclosure.

FIGS. 13A-13C is a series of views illustrating an example filter being deployed from a folded orientation to a partially unfolded orientation adjacent to an exterior surface of a basket, basin, or sink, according to an embodiment of the disclosure. The filter shown in FIGS. 13A-13C can be similar to the filter 100 shown in FIGS. 1 to 12. In another embodiment of the process, a filter can be similar to the filter 300 shown in FIGS. 14 and 15.

In FIG. 13A, the example filter 100 can be partially unfolded from a folded orientation. The filter 100 can be unfolded along one or more folds in the filter, wherein each of the one or more folds permits each of the plurality of panels to overlap an adjacent portion of the filter.

In FIG. 13B, the example filter 100 in a partially unfolded orientation can be disposed atop an exterior surface of a basket, basin, or sink 200, wherein an exterior edge of the indentation is disposed around an external surface of a base of a faucet when the filter is disposed atop the exterior surface of the basket, basin, or sink.

In FIG. 13C, the example filter 100 can be positioned such that an exterior edge of the indentation is disposed around an external surface of a base of a faucet 202 associated with the sink 200 when the filter 100 is disposed atop the exterior surface of the basket, basin, or sink 200. The peripheral region 102 and plurality of tabs of the filter 100 can be positioned along the exterior surface of the basket, basin, or sink 200 to help maintain the position of the filter 100 with respect to the basket, basin, or sink 200. In some instances, portions of the peripheral region 102 and one or more of the plurality of tabs of the filter 100 can be wetted using water from the faucet 202 to facilitate mounting the filter 100 atop the exterior surface of the basket, basin, or sink 200, thereby assisting in maintaining the position of the filter 100 relative to the basket, basin, or sink 200.

In another embodiment of the disclosure, an associated manufacturing process for a disposable filter for a basket, basin, or sink can be provided. The process can include providing a suitable filter material, providing a die to mold the filter material, and molding the filter material to manufacture a disposable filter for a basket, basin, or sink. The filter can be the filter 100 shown and described with respect to FIGS. 1 to 12. One will recognize the applicability of the principles and concepts described herein to this and other embodiments, such as embodiments with different polygon-shaped filters and/or embodiments with three, four, or five panels extending to the peripheral region.

In one aspect of the embodiment, the process can include molding the filter to make the central collection region square-shaped, and the one or more panels rectangular-shaped.

In one aspect of the embodiment, the process can include molding the filter to make the one or more folds comprising a set of origami-type folds that permits twisting of the filter around a central axis when unfolding the filter from the folded orientation to the partially unfolded orientation.

In one aspect of the embodiment, the process can include molding the filter to make the one or more folds comprising at least one of the following: a square twist, and a tessellation fold.

With respect to the methods and processes described above, one will recognize that each operation of the methods and processes may be performed in conjunction with other operations either described herein or within the scope of other embodiments of the disclosure. Further, one will recognize that the order of the operations of the methods and processes may be performed in another sequence than that described.

As used herein, the word “exemplary” is used to mean “serving as an example, instance, or illustration.” Any embodiment described herein as “exemplary” is not necessarily to be construed as preferred or advantageous over other embodiments.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

It is understood that the above descriptions are for purposes of illustration and are not meant to be limiting. Although specific embodiments of the disclosure have been described, numerous other modifications and embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or operations. Thus, such conditional language is not generally intended to imply that features, elements, and/or operations are in any way required for one or more embodiments.

The claimed disclosure is:

1. A filter for a basket, basin, or sink, the filter comprising:
a filter having a peripheral region, a plurality of panels, and a central collection region, the peripheral region having an upper surface and a lower surface, and the plurality of panels extending from the central collection region towards the peripheral region; and
one or more folds in the filter, each of the one or more folds permitting each of the plurality of panels to overlap an adjacent portion of the filter, wherein the filter can be unfolded from a folded orientation to a partially unfolded orientation.
wherein the filter is removably disposed atop an exterior surface of a basket, basin, or sink.

2. The filter of claim 1, further comprising:
at least one tab along the exterior edge of the peripheral region.

3. The filter of claim 1 further comprising:
an indentation in an exterior edge of the peripheral region, wherein the indentation is disposed around an external surface of a base of a faucet when the filter is disposed atop the exterior surface of the basket, basin, or sink.

4. The filter of claim 1 wherein the filter comprises at least one of the following: bleached or unbleached liquid permeable filter paper, liquid permeable filter paper, metal mesh material, plastic mesh material, natural fiber material, and synthetic fabric.

5. The filter of claim 1, wherein the central collection region is polygon-shaped, and the plurality of panels is polygon-shaped.

6. The filter of claim 1, wherein the plurality of panels is four.

7. The filter of claim 1, wherein the one or more folds comprises a set of origami-type folds that permits twisting of the filter around a central axis when unfolding the filter from the folded orientation to the partially unfolded orientation.

8. The filter of claim 1, wherein the one or more folds comprises at least one of the following: a square twist, and a tessellation fold.

9. A method for installing a filter for a basin or sink, the method comprising:
providing a filter having:
a peripheral region,
a plurality of panels,
a central collection region, the rim having an upper surface and a lower surface, and the plurality of panels extending from the central collection region towards the peripheral region;
and
unfolding the filter along one or more folds in the filter, each of the one or more folds permitting each of the plurality of panels to overlap an adjacent portion of the filter, wherein the filter can be unfolded from a folded orientation to a partially unfolded orientation.
disposing the filter atop an exterior surface of a basket, basin, or sink.

10. The method of claim 9, wherein the filter further comprises at least one tab along the exterior edge of the peripheral region.

11. The method of claim 9, wherein the filter comprises at least one of the following: bleached or unbleached liquid permeable filter paper, metal mesh material, plastic mesh material, natural fiber material, and synthetic fabric.

12. The method of claim 9, wherein the central collection region is square-shaped, and the plurality of panels is polygon-shaped.

13. The method of claim 9, wherein the plurality of panels is four.

14. The method of claim 9, wherein the one or more folds comprises a set of origami-type folds that permits twisting of the filter around a central axis when unfolding the filter from the folded orientation to the partially unfolded orientation.

15. The method of claim 9, wherein the one or more folds comprises at least one of the following: a square twist, and a tessellation fold.

16. A manufacturing process for a tilter for a basket, basin, or sink, the process comprising:
providing a filter material;
providing a die to mold the filter material;
molding the filter material to manufacture a disposable filter for a basin or sink, the filter comprising:
a peripheral region;
a plurality of panels;
a central collection region, the peripheral region having an upper surface and a lower surface, and the plurality of panels extending from the central collection region towards the peripheral region;
and
one or more folds in the filter, each of the one or more folds permitting each of the plurality of panels to overlap an adjacent portion of the filter, wherein the filter can be unfolded from a folded orientation to a partially unfolded orientation.

17. The process of claim 16, wherein molding the filter further comprises molding the filter to make the central collection region square-shaped, and the plurality of panels rectangular-shaped.

18. The process of claim 16, wherein molding the filter further comprises molding the filter to make the one or more folds comprising a set of origami-type folds that permits twisting of the filter around a central axis when unfolding the filter from the folded orientation to the partially unfolded orientation.

19. The process of claim 16, wherein molding the filter further comprises molding the filter to make the one or more folds comprising at least one of the following: a square twist, and a tessellation fold.

20. The process of claim 16, wherein the filter further comprises a concave-shaped indentation in an exterior edge of the peripheral region; and
a plurality of tabs along the exterior edge of the rim, wherein one of the plurality of tabs is disposed adjacent the concave-shaped indentation.
